(19) United States
(12) Patent Application Publication
(10) Pub. No.: US 2014/0012658 A1
(43) Pub. Date: Jan. 9, 2014

(54) ADVERTISEMENT TESTING APPARATUS AND METHOD

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/543,443

(22) Filed: Jul. 6, 2012

(51) Int. Cl. G06Q 30/02; G06Q 20/20

(52) U.S. Cl. 705/14.42; 705/14.41

(57) ABSTRACT

A method is disclosed for testing the effectiveness of one or more advertisements. The method may include conducting a plurality of point-of-sale transactions. In conjunction with these transactions, an advertisement may be presented a first number of times. Each time the advertisement is presented, it may contain a machine-readable code encoded with an identification unique to the advertisement. A computer system may receive first data identifying the number of times the advertisement is presented. The computer system may further receive second data identifying the number of times a machine-readable code encoded with the identification is scanned by a customer. Accordingly, the computer system may calculate and display a success rate for the advertisement.

### BACKGROUND

1. Field of the Invention

This invention relates to point-of-sale systems and more particularly to systems and methods for testing the efficacy of advertisements presented at one or more points-of-sale.

2. Background of the Invention

Many point-of-sale (POS) systems currently in use today do not support important emerging technologies, services, and marketing opportunities. For example, many POS systems are limited in their ability to test the efficacy of advertisements present at the point-of-sale. As a result, those POS systems cannot effectively implement many novel methods and services that make use of such advertisements. Accordingly, what is needed is an apparatus and method expanding the ability of a wide variety of POS systems, include legacy POS systems, to test the efficacy of certain advertisements.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of one embodiment of a point-of-sale (POS) system for implement methods in accordance with the present invention;

FIG. 2 is a schematic block diagram of one embodiment of multiple POS systems in accordance with the present invention operating in the context of an enterprise-wide system;

FIG. 3 is a schematic block diagram of one embodiment of receipt in accordance with the present invention;

FIG. 4 is an illustration showing how a card reader (e.g., credit card reader, debit card reader) may be used as a customer-facing display in certain embodiments in accordance with the present invention;

FIG. 5 is a schematic block diagram of one embodiment of an image module in accordance with the present invention;

FIG. 6 is a schematic block diagram of one embodiment of a testing module in accordance with the present invention;

FIG. 7 is an illustration of one embodiment of an advertisement displaying content and a machine-readable code in accordance with the present invention;

FIG. 8 is an illustration of an alternative embodiment of an advertisement displaying content and a machine-readable code in accordance with the present invention;

FIG. 9 is a block diagram of one embodiment of a method for testing multiple advertisements in accordance with the present invention; and

FIG. 10 is a block diagram illustrating the flow of data within one embodiment of system in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for testing the effectiveness of certain advertisements. For example, in selected embodiments, it may be beneficial to test the efficacy of one or more unique graphical or image-based advertisements presented to customers via a paper receipt printed by a POS system, a customer-facing display connected to a POS system, or the like.

In selected embodiments, an advertisement may include a call to action inviting or motivating a customer to take a particular step or action. To increase the likelihood that a consumer will respond favorably to the call to action, an advertisement may include a machine-readable code. Upon scanning the code, a consumer may be directed to a desired website or resource, initiate the download of a particular application or resource, or the like.

In certain embodiments, a machine-readable code may comprise a two-dimensional barcode (e.g., a Quick Response (QR) Code). The data encoded within a machine-readable code may vary between different embodiments and different purposes or goals of the advertisement. In selected embodiments, a machine-readable code may encode a transaction identification (ID) uniquely identifying a particular transaction (e.g., purchase, return, or the like). Alternatively, or in addition thereto, a machine-readable code may encode an advertisement ID (e.g., an ID indicating which particular combination of call to action, graphics, or the like accompanied the machine-readable code).

In general, the purpose of an advertisement and the various components thereof may be to benefit, economically or otherwise, a consumer, an entity (e.g., an entity selling goods or services to the consumer), or some combination thereof. For example, in selected embodiments, an advertisement may support or enable storage of transaction data, budgeting, electronic search of transaction data, couponing, shopping lists, electronic backup of transaction data, sharing of transaction data with family, friends, and/or co-workers, tracking of expenses for business or tax purposes, or the like or combinations or sub-combinations thereof. In certain embodiments, one purpose of an advertisement may be to transition a customer from using paper receipts to using electronic (i.e., paperless) receipts. This purpose, as well as others mentioned above, may be furthered by testing the effectiveness of one or more advertisements to enable and support systematic improvement thereof.

For example, after one more advertisements have been obtained or generated, one or more POS systems may conduct multiple transactions. In association with the transactions, the advertisements may be presented to customers. The number and identity of advertisements presented (e.g., presentation data) may be recorded. If an advertisement is successful, it may be scanned by a customer (e.g., a customer may scan a machine-readable code contained within an advertisement using the camera of his or her mobile telephone).

In selected embodiments, a machine-readable code may be encoded with a URL. In addition to designating a particular resource, a URL may also include an advertisement ID and a transaction ID. Accordingly, when a machine-readable code is scanned, a request based on the URL may be generated. The request may include the advertisement ID and transaction ID. Thus, a web server may collect these identifications and pass them to a desired location or resource within the system. This information may constitute response data documenting the fact that a particular advertisement was scanned. Using the presentation and response data, statistics characterizing customer response to one or more advertisements may be collected and uses to make improvements. A system in accordance with the present invention may, therefore, move with greater efficiency and speed toward accomplishing the purpose or purposes of the various advertisements.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

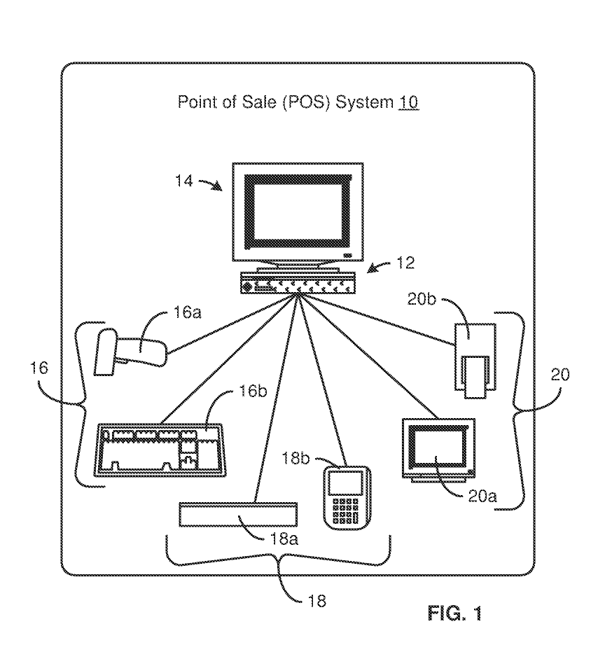

Referring to FIG. 1, in selected embodiments, the hardware, software, or hardware and software of a POS system 10 may be configured to implement one or more methods in accordance with the present invention. For example, a POS system 10 may be manufactured, programmed, modified, or upgraded to support image-embedding capabilities.

A POS system 10 in accordance with the present invention may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 in accordance with the present invention may include an accounting interface to pass certain information to one or more in-house or independent accounting applications.

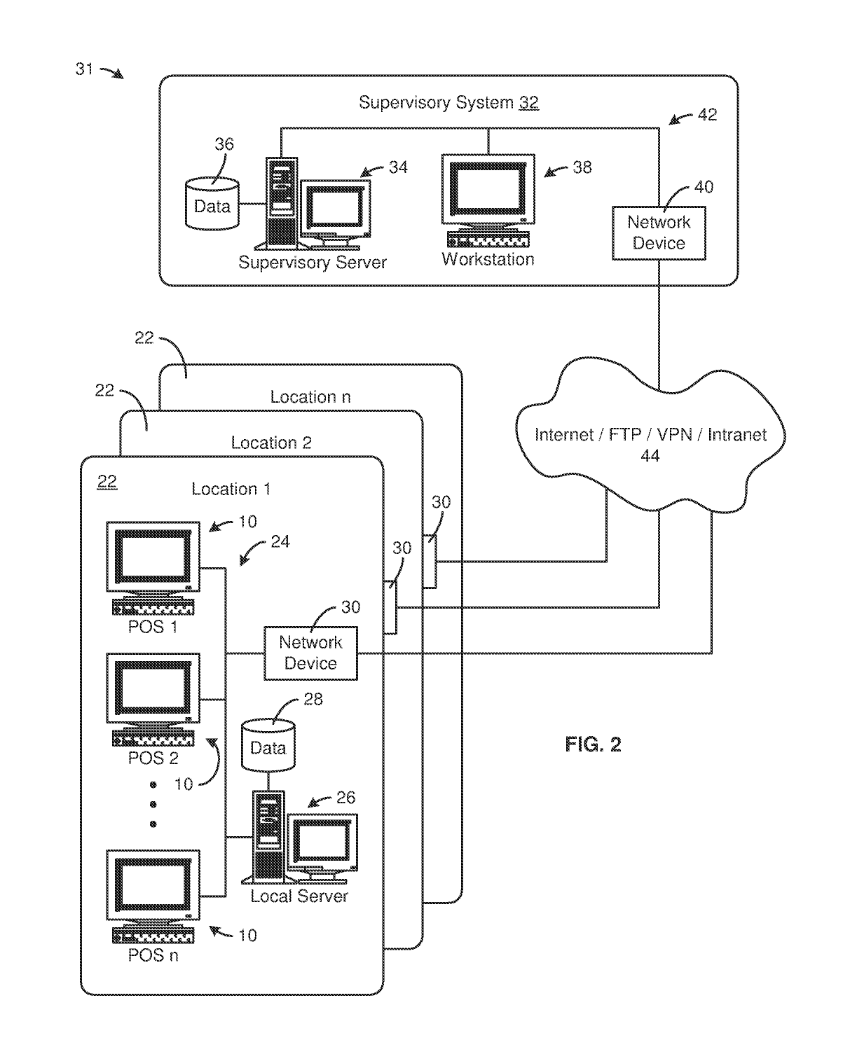

Referring to FIG. 2, in selected embodiments, a POS system 10 may operate substantially independently, as a stand-alone unit. Alternately, a POS system 10 in accordance with the present invention may be one of several POS systems 10 forming the front line of a larger system. For example, multiple POS systems 10 may operate at a particular location 22 (e.g., within a retail, brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 in accordance with the present invention may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

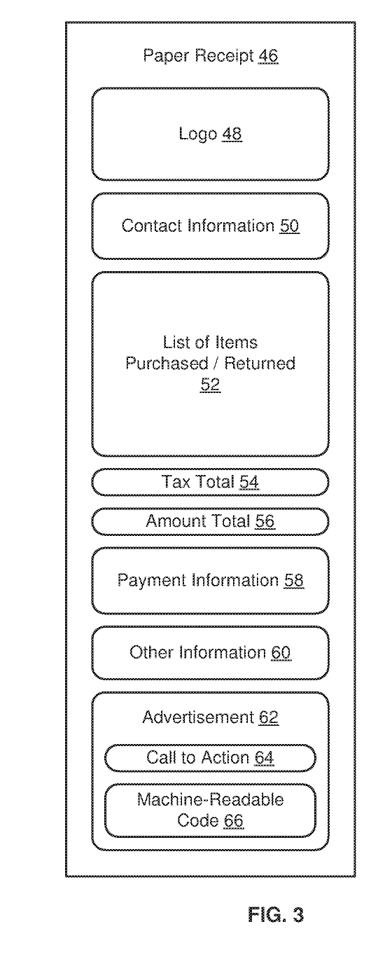

Referring to FIG. 3, in selected embodiments in accordance with the present invention, a POS system 10 may output a receipt 46. For example, a printer 20b of a POS system 10 may output a paper receipt 46. A receipt 46 may perform various functions. Primarily, a receipt 46 may document a financial transaction (e.g., sale or return). However, a receipt 46 may also deliver one or more marketing messages to a consumer. In selected embodiments, a receipt 46 may include a logo 48, contact information 50, a list 52 of items purchased or returned, a total 54 indicating the sales tax assessed or returned, a total 56 indicating 56 the amount paid or returned, payment information 58, other information 60, or the like or combinations or sub-combinations thereof.

A logo 48 may reinforce the brand and image of the associated entity within the mind of a consumer. By including contact information 50 on a receipt 46, an entity may ensure that a customer has ready access to one or more physical addresses, Internet address, telephone numbers, facsimile numbers, hours of operation, or the like or combinations or sub-combinations thereof. One or more of a list 52 of items purchased or returned, a total 54 indicating the sales tax assessed or returned, a total 56 indicating 56 the amount paid or returned, and payment information 58 (e.g., date of transaction, an indication of method of payment, an indication of which credit or debit card was used, etc.) may be included to document important details of a transaction.

Other information 60 may be included within a receipt 46 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

In selected embodiments, a receipt 46 may include an advertisement 62. An advertisement 62 may include a call to action 64 inviting or motivating a recipient of the receipt 46 to take a particular step or action. For example, a call to action 64 may invite or motive a consumer to visit a particular website, download a particular application, or the like. To increase the likelihood that a consumer will respond favorably to the call to action 64, an advertisement 62 may include an enabler facilitating the desired step or action. For example, in selected embodiments, an advertisement 62 may include a machine-readable code 66. Upon scanning the code 66 (e.g., scanning the code 66 using a camera on a mobile computing device such as mobile telephone, personal digital assistant (PDA), or tablet computer or reader, or the like), a consumer may be directed to a desired website (e.g., a particular URL), initiate the download of a particular application, initiate the download of a resource corresponding to a transaction (e.g., an electronic receipt), or the like.

A machine-readable code 66 may comprise a barcode. For example, in certain embodiments, a machine-readable code 66 may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

The data encoded within a machine-readable code 66 may vary between different embodiments and different purposes (e.g., purposes or goals of an advertisement 62). In selected embodiments, a machine-readable code 66 may encode a transaction identification (ID). A transaction ID may uniquely identify a particular transaction (e.g., a transaction documented by a corresponding receipt 46). Alternatively, or in addition thereto, a machine-readable code 66 may further encode an advertisement ID (e.g., an ID indicating which particular combination of call to action 64, graphics, or the like accompanied the machine-readable code 66). A machine-readable code 66 may also encode a web address or URL.

As with a machine-readable code 66, the nature or characteristics of an advertisement 62 and call to action 64 may vary according to a purpose thereof. In general, the purpose of an advertisement 62 and the various components 64, 66 thereof may be to benefit, economically or otherwise, a consumer, an entity (e.g., an entity issuing the receipt 46), or some combination thereof. For example, in selected embodiments, the purpose of an advertisement 62 may be to transition a customer from using paper receipts 46 to using electronic (i.e., paperless) receipts.

At one level, the use of electronic receipts may conserve natural resources by reducing the need for and consumption of paper. However, the use of electronic receipts may have other advantages to both a consumer and an entity issuing the electronic receipts. For example, electronic receipts may enable a consumer to more easily collect and keep a highly detailed record of his or her spending. Entities issuing electronic receipts may benefit from additional marketing opportunities that the electronic receipts provide.

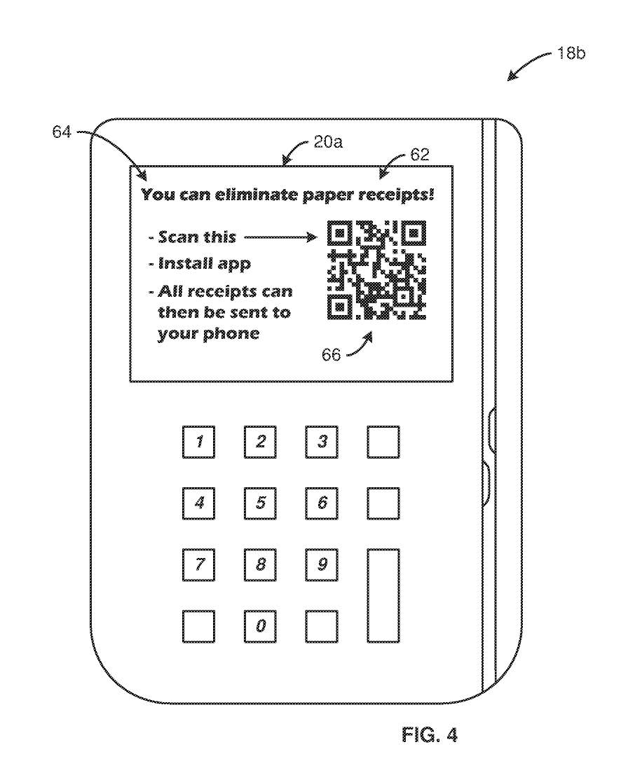

Referring to FIG. 4, as set forth hereinabove, an advertisement 62 may be presented to a customer via a printed receipt 46. Alternatively, or in addition thereto, an advertisement 62 (e.g., the same advertisement 62 or a different advertisement 62) may be presented to a customer via some other output mechanism 20. For example, in selected embodiments, one or more advertisements 62 may be presented to a customer via a customer-facing display 20a screen 20a.

A customer-facing display 20a may take various forms. In selected embodiments, a customer-facing display 20a may be embodied as a stand-alone monitor dedicated to presenting information, advertisements 62, or the like to a customer at a POS. Alternatively, a customer-facing display 20a may be a multi-use screen capable of performing various functions. For example, in certain embodiments, a customer-facing display 20a may be embodied as a screen on a card reader 18b. That is, during at least some portion of a transaction, an advertisement 62 may be displayed on a screen or a portion of a screen of a card reader 18b.

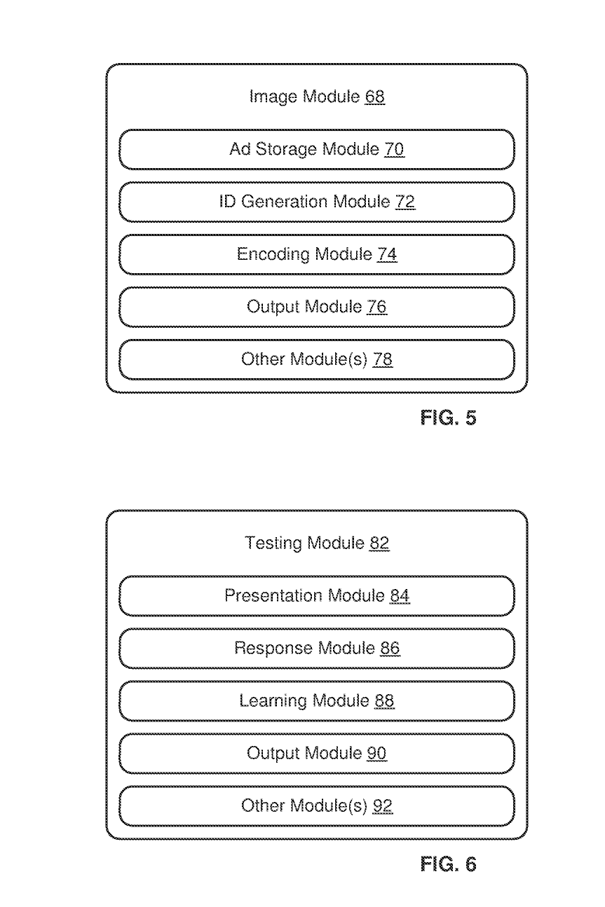

Referring to FIG. 5, in general, consumers rely heavily on visual cues. Accordingly, an advertisement 62 may include a significant graphical component. That is, an advertisement 62 in accordance with the present invention may impact a consumer through images, stylization, or the like, rather than just through plain text. Thus, in certain embodiments, some portion or all of an advertisement 62 may be passed within a POS system 10 as an image and printed or displayed as an image, not as text. For example, an advertisement 62 (or a significant portion thereof) may be passed to a receipt printer 20b or customer-facing display 20a in a stream including a raster-coded image or bitmap.

In selected embodiments, an image module 68 may be tasked with obtaining or generating one or more images associated with an advertisement 62. For example, an image module 68 may obtain, generate, and/or assemble one or more advertisements 62 and deliver the one or more advertisements 62 to a receipt printer 20b, customer-facing display 20b, or the like or some combination thereof. An image module 68 may include any suitable arrangement of sub-components or modules. In certain embodiments, an image module 68 may include a storage module 70, ID generation module 72, encoding module 74, and output module 76, one or more other modules 78 as desired or necessary, or the like or some combination or sub-combination thereof.

A storage module 70 may enable an image module 68 to receive, store, index, and/or retrieve one or more images. For example, in certain embodiments, a storage module 70 may provide or support the receiving, storing, indexing, and/or retrieving of one or more image templates used in assembling one or more advertisements 62. An image template may be an image (e.g., a digital image, raster-coded image, bitmap, or the like) coded to display some content and one or more placeholders.

The content of an image template may have any suitable form. In selected embodiments, the content of a template may include one or more graphical elements (e.g., non-readable elements, shapes, icons, illustrations, or the like), one or more readable elements (e.g., stylized text or a written call to action 64 in image form), or the like or some combination or sub-combination thereof. A placeholder of an image template may correspond to, and provide, a space for a machine-readable code 66, transaction-specific image, or the like.

That is, one or more templates may be prepared and stored in memory (e.g., some memory device or collection of memory devices within a POS system 10, location 22, or enterprise-wide system 31) before a transaction at a POS system 10 is initiated. For example, a graphic artist or designer may prepare one or more templates highlighting different messages, themes, or the like applicable to different situations or transactions long before a particular transaction is initiated at a POS system 10. Since a machine-readable code 66 may be encoded with transaction-specific information, it may not be included within a template at the time of its original creation.

However, the placement (e.g., location, size, orientation, etc.) of a machine-readable code 66 or other transaction-specific image with respect to the content may be important to the work and goals of the artist or designer. Accordingly, the artist or designer may incorporate one or more placeholders within a template. The location, size, and orientation of a placeholder may respectively indicate the desired location, size, and orientation of the machine-readable code 66, transaction-specific image, or the like in the final product (e.g., the final image presented to a customer).

An ID generation module 72 may generate one or more identifications to be incorporated within an advertisement 62. For example, an ID generation module 72 may obtain or generate an ID unique to each transaction processed within a POS system 10, location 22, or enterprise-wide system 31. Alternatively, or in addition thereto, an ID generation module 72 may obtain or generate an ID for each advertisement 62 (e.g., each advertisement 62 of different content) processed within a POS system 10, location 22, or enterprise-wide system 31.

An encoding module 74 may generate a machine-readable code 66 encoded with various data, including a transaction ID, advertisement ID, uniform resource identifier (URI), or the like or some combination or sub-combination thereof. In selected embodiments, a machine-readable code 66 may be embodied as a digital image coded to display content that is machine-readable. For example, in certain embodiments, a machine-readable code 66 may be embodied as a digital image coded to display a QR Code of the like.

Once generated, a machine-readable code 66 may be applied to a template. Accordingly, a resulting advertisement 62 may comprise a digital image formed when an image template is modified such that one or more placeholders therewithin are respectively replaced with one or more machine-readable codes 66, transaction-specific images (e.g., non-readable images or readable images displaying timestamps, dates, website information (URL), etc.), or the like or combinations or sub-combinations thereof.

A completed advertisement 62 may be stored within a memory device or collection of memory devices corresponding to a POS system 10, location 22, enterprise-wide system 31, or some other resource. For example, in selected embodiments, an output module 76 may pass an advertisement 62 to the memory of a receipt printer 20b. Alternatively, or in addition thereto, an advertisement 62 may be passed to or read by a customer-facing screen 20a for display thereon.

The various functions or modules of an image module 68 may be enacted or implemented by any suitable system or component thereof. For example, in selected embodiments, an image module 68 may be implemented partially or entirely as a “virtual printer” or monitor driver residing on a primary computer 12 of a POS system 10. Alternatively, one or more functions or modules of an image module 68 may be enacted or implemented by a “box” positioned in the line of communication between a primary computer 12 and a receipt printer 20b or between a primary computer 12 and a customer-facing display 20a. A box may monitor and modify certain communications passing between the computer 12 and the printer 20b or display 20a. A box may access a LAN 24 or WAN 44 to gather additional resources or information as necessary.

In still other embodiments, one or more functions or modules of an image module 68 may be distributed across various hardware devices, including a primary computer 12 of a POS system 10, a local server 26, a supervisory server 34, an onsite resource, an offsite resource, or the like or combinations or sub-combinations thereof. Thus, systems and methods in accordance with the present invention may be adapted to a wide variety of situations, including more rigid legacy systems.

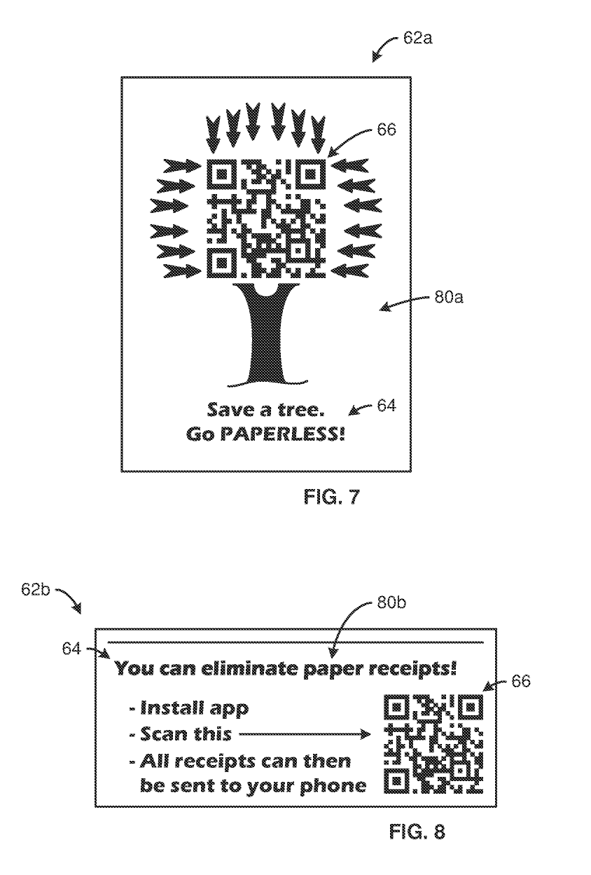

Referring to FIGS. 6-8, in selected embodiments, data reflecting real world performance of one or more advertisements 62 may enable or support improvement in that performance. That is, different advertisements 62 may have different success rates. A success rate may reflect a comparison between the number of times an advertisement 62 is presented to consumers (e.g., a number of impressions) and the number of times consumers act on the advertisement 62. By tracking the success rates of one or more advertisements 62, better, more successful advertisements 62 may be created, tested, and deployed.

For example, a first advertisement 62a may include first content 80a and a first machine-readable code 66a. A second advertisement 62b may have second content 80b distinct in some manner from the first content 80a and a second machine-readable code 66b. Using one or more POS systems 10 within a location 22, enterprise-wide system 31, or the like, the first and second advertisements 62a, 62b may each be presented to a certain number of consumers via a printed receipt 47, a customer-facing display 20a, or the like or some combination thereof. Each machine-readable code 66 presented as part of the advertisements 62a, 62b may include an advertisement ID identifying the advertisement 62a, 62b associated therewith. Accordingly, when a machine-readable code 66 is scanned by a consumer, data identifying the associated advertisement 62a, 62b may be collected.

By dividing the number of times consumers act on an advertisement 62a, 62b (e.g., the number of unique or first time scans of machine-readable codes 66 associated with an advertisement 62a, 62b) by the number of times the advertisement 62a, 62b is presented to consumers, a success rate for each advertisement 62a, 62b may be determined. Accordingly, one advertisement 62a, 62b may be determined to have performed better than another advertisement 62b, 62a. Such data may enable “A/B testing,” multivariate testing, or other designed experiments or learning that supports data-driven improvement. For example, advertisements 62 that perform better may be displayed to customers more frequently (e.g., if an advertisement 62 performs better in one or more aisles, POS systems 10, departments, stores 22, regions, enterprises 31, or the like, it may be displayed more frequently in one or more of those locations).

In selected embodiments, a testing module 82 may enable, support, or manage one or more designed experiments. For example, a testing module 82 may collect, store, and process data corresponding to advertisement impressions and responses to highlight or identify certain facts, trends, or the like that may be leveraged for benefit or improvement. A testing module 82 may include any suitable arrangement of sub-components or modules. In certain embodiments, a testing module 82 may include a presentation module 84, response module 86, learning module 88, output module 90, one or more other modules 92 as desired or necessary, or the like or some combination or sub-combination thereof. The various functions or modules of a testing module 82 may be supported by or run on one or more hardware devices, including a primary computer 12 of a POS system 10, a local server 26, a supervisory server 34, an onsite resource, an offsite resource, or the like or combinations or sub-combinations thereof.

A presentation module 84 may collect, store, and process data corresponding to advertisement presentations or impressions. For example, a presentation module 84 may collect a count of how many times an advertisement 62 (e.g., one or more advertisements 62 having identical content 80 but different encodings within respective machine-readable codes 66) is presented on receipts 46 or customer-facing displays 20a. A presentation module 84 may collect this information from one or more POS systems 10, one or more locations 22, an entire enterprise wide system 31, or the like.

A response module 86 may collect, store, and process data corresponding to advertisement responses. For example, a response module 86 may collect a count of how many times an advertisement 62 (e.g., one or more advertisements 62 having identical content 80 but different encodings within respective machine-readable codes 66) is scanned. In selected embodiments, one or more machine-readable codes 66 may be encoded with a transaction ID rendering each code 66 thereof (and associated advertisement 62) unique within a POS system 10, location 22, or enterprise-wide system 31. Accordingly, a response module 86 may use transaction-ID data collected from one or more POS systems 10, one or more locations 22, or an entire enterprise-wide system 31 to ensure that the counts collected are not distorted by redundant scans of the exact same machine-readable code 66.

A learning module 88 may use data collected by a presentation module 84 and a response module 86 to calculate one or more success rates, identify statistically significant patterns or trends, or the like. In certain embodiments, a learning module 88 may interpret the data and suggest or implement certain improvements or changes. For example, a learning module 88 may use the effectiveness of a call to action 64 to automatically dictate the frequency that the call to action 64 is shown to consumers (e.g., a learning module 88 may automatically identify one or more advertisements 62 that perform better in certain locations and automatically issue instructions that the one or more advertisements 62 be displayed more frequently in one or more of those locations). Alternatively, or in addition thereto, a learning module 88 may provide a mechanism through which one or more human users may inspect, sort, analyze, or otherwise process or interpret data.

An output module 90 may provide a mechanism for outputting data, plots, graphs, or the like. Alternatively, or in addition thereto, an output module 90 may provide a mechanism for implementing one or more experiments. For example, an output module 90 may enable, support, or issue commands dictating which advertisements 62 or advertisement templates are to be used and how they are to be used.

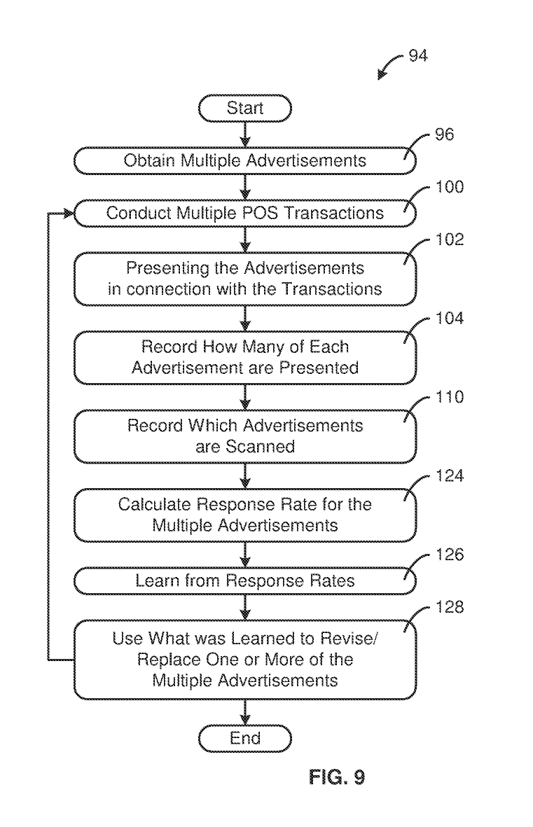

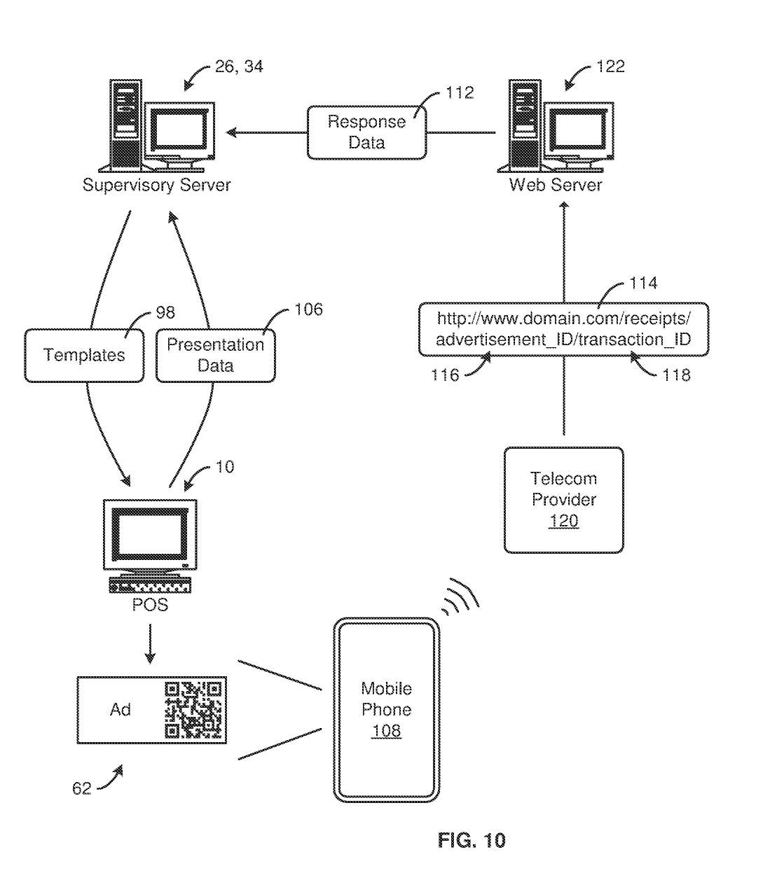

Referring to FIGS. 9 and 10, one method 94 in accordance with the present invention may begin when one or more advertisements 62 are obtained 96 or generated 96. The advertisements 62 may be obtained 96 or generated 96 by one or more POS systems 10. In selected embodiments, the POS systems 10 may base the advertisements 62 on one or more templates 98 provided thereto by a local server 26, supervisory server 34, or some other resource.

One or more POS systems 10 may then conduct 100 multiple POS transactions. In association with the transactions, the advertisements 62 may be presented 102. For example, a receipt 46 generated at the end of a POS transaction may include an advertisement 62. Alternatively, or in addition thereto, an advertisement 62 may be presented 102 via a customer-facing display 20a at some time during or after a transaction. The number and identity of advertisements 62 presented 102 may be recorded 104. In selected embodiments, such data (e.g., presentation data 106) may be passed from one or more POS systems 10 to a local server 26, a supervisory server 34, or the like.

Should a customer feel so inclined, he or she may scan a machine-readable code 66 of an advertisement 62 presented 102 to him or her. For example, a customer may scan an advertisement 62 using the camera of a mobile telephone 108. This scan may be passed to and recorded 110 by a local server 26, a supervisory server 34, other resource, or the like. However, the path of such data (e.g., response data 112) need not follow the same path as the presentation data 106.

For example, in selected embodiments, a machine-readable code 66 may be encoded with a URL 114. In addition to designating a particular resource, a URL 114 may also include certain identifications. For example, a URL may include an advertisement ID 116 and a transaction ID 118. In operation, a URL 114 may be passed from a customer (e.g., from a mobile telephone 108 of a customer) to an Internet Service Provider (e.g., a telecommunications provider 120). As a result, a request may reach a web server 122 corresponding to the URL 114. The request may include the advertisement ID 116 and transaction ID 118. Thus, a web server 122 may collect these identifications 116, 118 and pass them as response data 112 to a local server 26, a supervisory server 34, other resource, or the like. Accordingly, the fact that a particular advertisement 62 (e.g., machine-readable code 66 associated with the particular advertisement 62) was scanned may be noted and recorded 110.

Using the data 106, 112 collected, a local server 26, supervisory server 34, or the like may calculate 124 a success rate for the one or more advertisements 62. Information (e.g., facts, trends, or the like) may be learned 126 from the respective success rates and the underlying statistical information. Accordingly, the information learned may be used 128 to revise or replace one or more advertisements 62 so that they will perform better in the future. This process may be iterated to progressively improve the rate at which one or more purposes behind an advertisement 62 is accomplished.

The flowchart and block diagrams in FIGS. 9 and 10 illustrate the architecture, functionality, and operation of possible implementations of systems, methods, and computer program products according to one embodiment of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for testing the effectiveness of one or more advertisements, the method comprising:
conducting a plurality of point-of-sale transactions;
presenting, in connection with the plurality of point-of-sale transactions, a first advertisement a first number of times, each time thereof the first advertisement containing a machine-readable code encoded with a first identification unique to the first advertisement;
receiving, by a computer system, first data identifying the first number of times;
receiving, by the computer system, second data identifying a second number of times, each time thereof corresponding to a scanning of a machine-readable code encode with the first identification; and
displaying, by the computer system, a comparison of the first number and the second number.

2. The method of claim 1, further comprising identifying one or more point-of-sale systems.

3. The method of claim 2, wherein the conducting comprising conducting the plurality of point-of-sale transactions using the one or more point-of-sale systems.

4. The method of claim 3, wherein the receiving first data comprises receiving, by the computer system from the one or more point-of-sale systems, the first data.

5. The method of claim 4, wherein the presenting comprising presenting the first advertisement the first number of times, each time thereof the first advertisement containing the machine-readable code encoded with a URL.

6. The method of claim 5, wherein the receiving second data comprises receiving, by the computer system from one or more web servers, the second data.

7. The method of claim 6, further comprising presenting, in connection with the plurality of point-of-sale transactions, a second advertisement a third number of times, each time thereof the second advertisement containing a machine-readable code encoded with a second identification unique to the second advertisement.

8. The method of claim 7, further comprising receiving, by the computer system, third data identifying the third number of times.

9. The method of claim 8, further comprising receiving, by the computer system, fourth data identifying a fourth number of times, each time thereof corresponding to a scanning of a machine-readable code encode with the second identification.

10. The method of claim 9, further comprising displaying, by the computer system, a comparison of the third number and the fourth number.

11. The method of claim 10, wherein the presenting the first advertisement the first number of times comprises printing the first advertisement on a plurality of paper receipts.

12. The method of claim 10, wherein the presenting the first advertisement the first number of times comprises displaying the first advertisement on a customer-facing display.

13. The method of claim 1, wherein the presenting the first advertisement the first number of times comprises printing the first advertisement on a plurality of paper receipts.

14. The method of claim 1, wherein the presenting the first advertisement the first number of times comprises displaying the first advertisement on a customer-facing display.

15. A method for testing the effectiveness of a plurality of advertisements, the method comprising:
conducting a plurality of point-of-sale transactions;
presenting, in connection with the plurality of point-of-sale transactions, a first advertisement a first number of times, each time thereof the first advertisement containing a machine-readable code encoded with a first identification unique to the first advertisement;
presenting, in connection with the plurality of point-of-sale transactions, a second advertisement a second number of times, each time thereof the second advertisement containing a machine-readable code encoded with a second identification unique to the second advertisement;
receiving, by a computer system, data identifying
the first number of times,
the second number of times,
a third number of times, each time thereof corresponding to a scanning of a machine-readable code encoded with the first identification, and
a fourth number of times, each time thereof corresponding to a scanning of a machine-readable code encoded with the second identification; and
using, by the computer system, the data to characterize the performance of the first and second advertisements.

16. The method of claim 15, further comprising identifying one or more point-of-sale systems.

17. The method of claim 16, wherein the conducting comprising conducting the plurality of point-of-sale transactions using the one or more point-of-sale systems.

18. The method of claim 17, wherein the receiving comprises receiving data identifying the first and second number of times from the one or more point-of-sale systems.

19. The method of claim 18, wherein the presenting the first advertisement comprises presenting the first advertisement the first number of times, each time thereof the first advertisement containing the machine-readable code encoded with a URL.

20. The method of claim 19, wherein the receiving comprises receiving, by the computer system from one or more web servers, data identifying the third number of times.

21. The method of claim 15, wherein the using comprises identifying the first advertisement as performing better than the second advertisement.

22. The method of claim 21, further comprising presenting, after the using, the first advertisement to consumers with greater frequency than the second advertisement.
